(19) United States
(12) Patent Application Publication
(10) Pub. No.: US 2021/0127857 A1
(43) Pub. Date: May 6, 2021

(54) MEMORABILIA BALL SIMULACRUM STAND AND SYSTEM

(71) Applicant: Lauren Cecchi, New York, NY (US)

(72) Inventor: Lauren Cecchi, New York, NY (US)

(21) Appl. No.: 16/668,046

(22) Filed: Oct. 30, 2019

(51) Int. Cl. A47F 7/00; G09F 7/08

(52) U.S. Cl. CPC A47F 7/0057; G09F 7/08

(57) ABSTRACT

A memorabilia ball simulacrum stand, the memorabilia ball simulacrum stand comprising: a base; a curved holder extending upward and orthogonally from the base, the base comprising: an outer perimeter located on an outer side of the curved holder; an inner perimeter located on an inner side of the curved holder; a first planar surface located on a left side of the curved holder, the first planar surface generally parallel to the base, the first planar surface abutting the outer perimeter and the inner perimeter; a second planar surface located on a right side of the curved holder; the second planar surface generally parallel to the base, the second planar surface abutting the outer perimeter and the inner perimeter; a curved slot located within the inner perimeter, the slot configured to hold a memorabilia ball simulacrum. A memorabilia ball simulacrum system, the memorabilia ball simulacrum system comprising: a stand, the stand comprising: a base; a curved holder extending upward and orthogonally from the base, the base comprising: an outer perimeter located on an outer side of the curved holder; an inner perimeter located on an inner side of the curved holder; a first planar surface located on a left side of the curved holder, the first planar surface generally parallel to the base, the first planar surface abutting the outer perimeter and the inner perimeter; a second planar surface located on a right side of the curved holder; the second planar surface generally parallel to the base, the second planar surface abutting the outer perimeter and the inner perimeter; a curved slot located within the inner perimeter; a memorabilia ball simulacrum configured to fit into the curved slot and curved holder.

### TECHNICAL FIELD

The present invention relates to a memorabilia ball simulacrum stand and system, and more particularly to a stand that is modified to hold and display and autographable memorabilia ball simulacrum

### BACKGROUND

When it comes to collecting autographs of well-known sport celebrities, personalities, and people, collectors have the tendency to use actual sports items used by the person. Sports items such as soccer balls are used for soccer players, footballs for football players, sports uniform jerseys for athletes, and the like. The problem encountered by this practice is the fact that the items may be cumbersome, or the person may not have one readily available to be autographed. One example would be having a soccer ball available for a soccer player to autograph. Individuals may use items such as napkins, scrap pieces of paper, menus or other random items to get autographs. After these items are signed, the majority of them end up being damaged, discarded or put away in a place they cannot be readily displayed and appreciated.

People seeking autographs of famous or notable individuals desire to have items related to the individual, such as a baseball card with the player's image on it, a picture of the person, or an item related to the signatory, such as a program. But such items may be difficult to obtain or carry on their person.

Another problem faced by individuals who are able to obtain autographs, on random items, is their items are diminished in their collectable values compared to what they might be able to get for autographed sports items for athletes. The item signed can also possibly be easily misplaced, or lost, and not be retained by the collector.

Once the fan obtains an autographable piece of memorabilia, the problem then becomes how to display that memorabilia. Often such autographed memorabilia ends up in a drawer or closet, never to be seen again. One could use a frame, but that requires making sure one purchases the correct size frame, then placing the memorabilia in the frame, and then hanging the frame with the proper tools and fasteners.

Thus there is a need for a memorabilia ball simulacrum stand and system that overcome the above listed and other disadvantages.

### SUMMARY OF THE INVENTION

The invention relates to a memorabilia ball simulacrum stand, the memorabilia ball simulacrum stand comprising: a base; a curved holder extending upward and orthogonally from the base, the base comprising: an outer perimeter located on an outer side of the curved holder; an inner perimeter located on an inner side of the curved holder; a first planar surface located on a left side of the curved holder, the first planar surface generally parallel to the base, the first planar surface abutting the outer perimeter and the inner perimeter; a second planar surface located on a right side of the curved holder; the second planar surface generally parallel to the base, the second planar surface abutting the outer perimeter and the inner perimeter; a curved slot located within the inner perimeter, the slot configured to hold a memorabilia ball simulacrum.

In addition, the invention relates to a memorabilia ball simulacrum system, the memorabilia ball simulacrum system comprising: a stand, the stand comprising: a base; a curved holder extending upward and orthogonally from the base, the base comprising: an outer perimeter located on an outer side of the curved holder; an inner perimeter located on an inner side of the curved holder; a first planar surface located on a left side of the curved holder, the first planar surface generally parallel to the base, the first planar surface abutting the outer perimeter and the inner perimeter; a second planar surface located on a right side of the curved holder; the second planar surface generally parallel to the base, the second planar surface abutting the outer perimeter and the inner perimeter; a curved slot located within the inner perimeter; a memorabilia ball simulacrum configured to fit into the curved slot and curved holder.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front perspective view of the disclosed memorabilia ball simulacrum stand;

FIG. 2 is a front view of the memorabilia ball simulacrum stand from FIG. 1;

FIG. 3 is a rear view of the memorabilia ball simulacrum stand from FIG. 1;

FIG. 4 is a side view of the memorabilia ball simulacrum stand from FIG. 1;

FIG. 5 is a top view of the memorabilia ball simulacrum stand from FIG. 1;

FIG. 6 is a bottom view of the memorabilia ball simulacrum stand from FIG. 1;

FIG. 7 is a perspective view of the memorabilia ball simulacrum stand from FIG. 1 with a memorabilia ball simulacrum placed in the stand;

FIG. 8 is a perspective view of the memorabilia ball simulacrum; and

FIG. 9 is a side view of the memorabilia ball simulacrum.

### DETAILED DESCRIPTION OF THE INVENTION

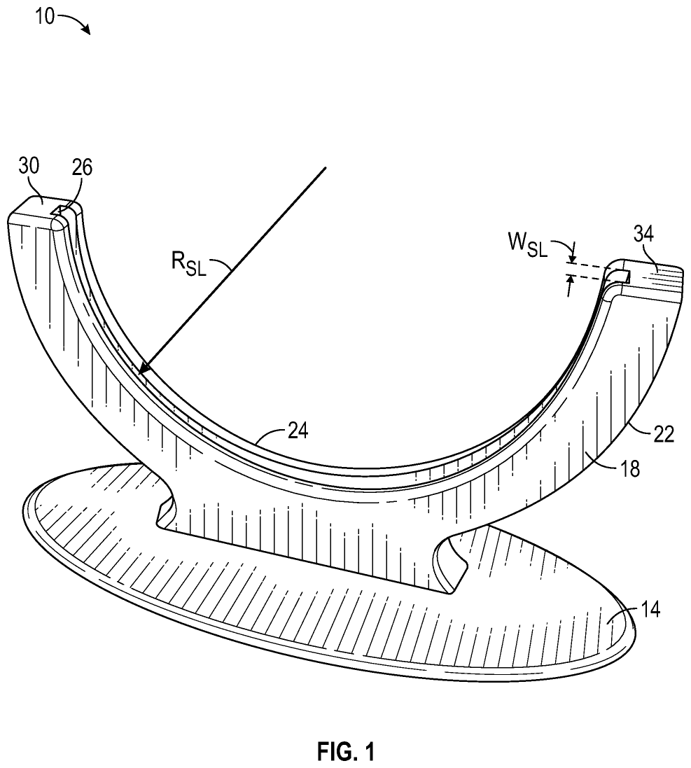

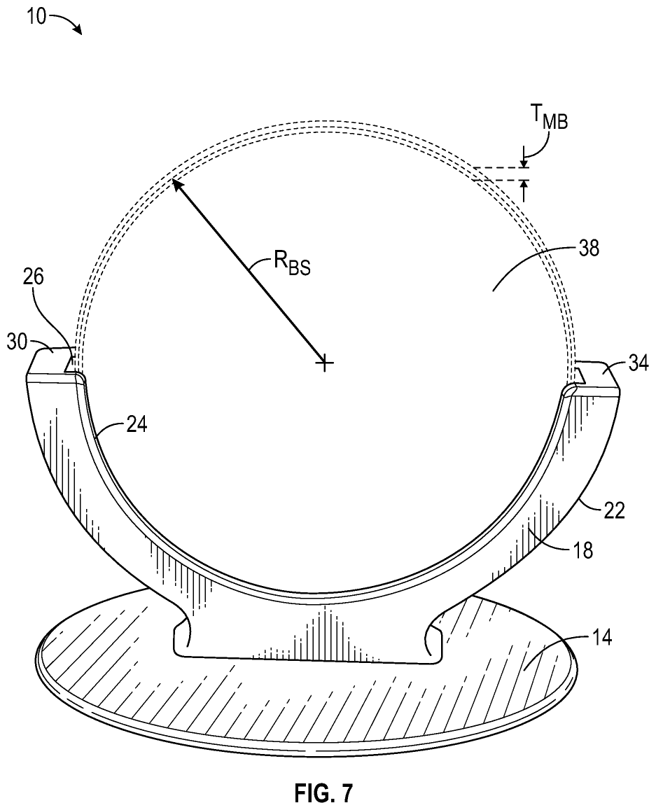

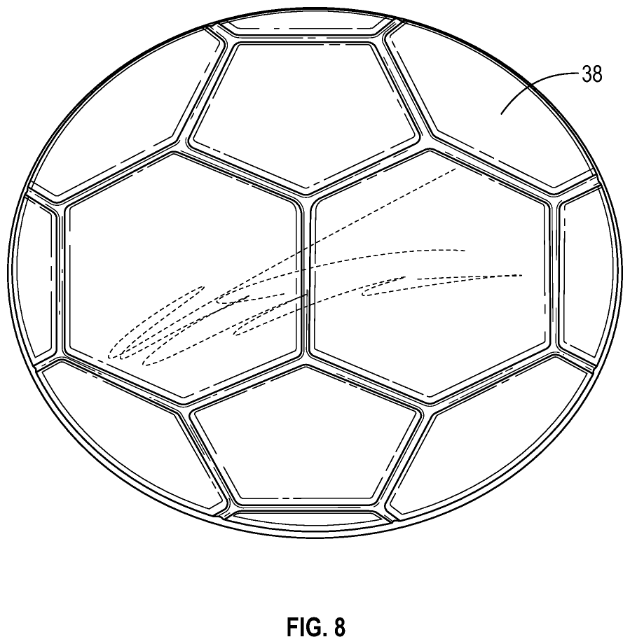

FIG. 1 is a perspective view of one embodiment of the memorabilia ball simulacrum stand 10. In this embodiment, the ball simulacrum may be a round ball, such as but not limited to a soccer ball, basketball, baseball, tennis ball, etc. However, the memorabilia ball simulacrum may be a simulacrum of any type of sports ball or piece of sports equipment that can fit onto the disclosed stand such as, but not limited to a basketball, tennis ball, baseball, ping pong ball, rugby ball, baseball bat, tennis racket, pickleball ball, pickleball paddle, ping pong paddle, hockey puck, hockey stick, etc. The memorabilia ball simulacrum stand 10 comprises a base 14, and a curved holder 18 that extends orthogonally from the base 14. The base 14 may have an oval shape in one embodiment. The curved holder 18 comprises an outer perimeter 22 and an inner perimeter 24. The inner perimeter 24 is parallel to portions of the outer perimeter 22. In one embodiment, the inner perimeter 24 has the shape of a portion of a first circle, and portions of the outer perimeter 24 also has the shape of a second circle, where the first and second circle have the same center. A curved slot 26 is located on the inner perimeter 24. The curved slot 26 may have a generally partial circular shape or arc shape. The curved slot 26 is configured to hold a memorabilia ball simulacrum, see FIGS. 7 and 8. The curved slot 26 may have generally the same radius as the memorabilia ball simulacrum. The radius of the curved slot 26 is shown by R_{SL}. The curved slot 26 may have a width W_{SL}.W_{SL} will generally be the same as the thickness of the memorabilia ball simulacrum. In other embodiments W_{SL} may be slightly smaller than the thickness of the memorabilia ball simulacrum for a press-fit or interference fit. The top of the curved holder may have two planar surfaces 30, 34 that are parallel to the base 14.

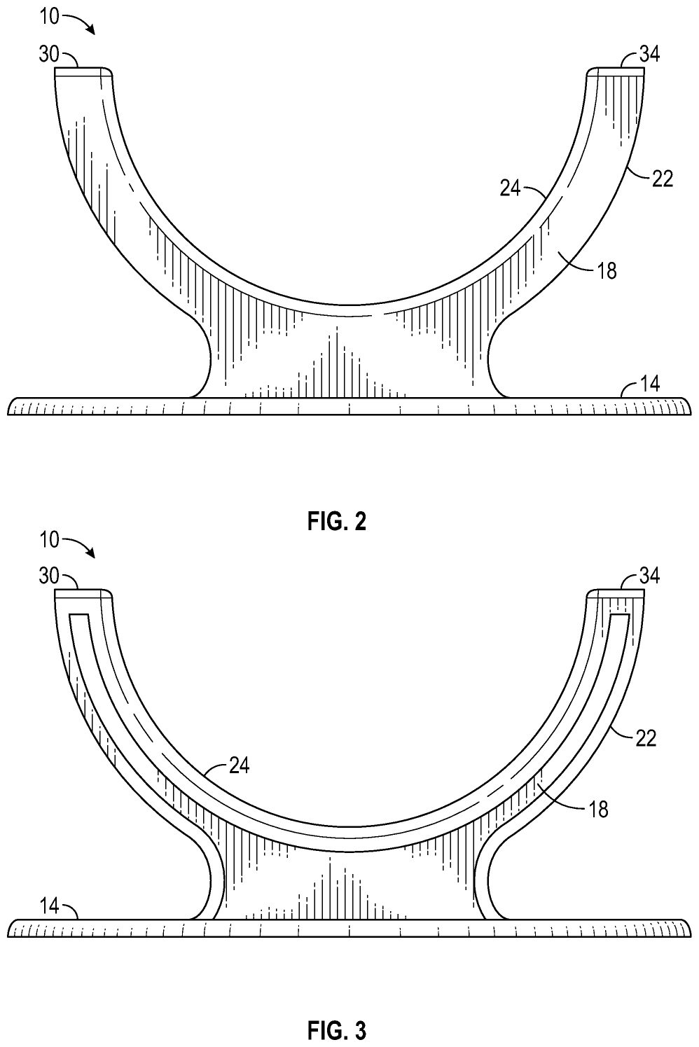

FIG. 2 is a front view of the memorabilia ball simulacrum stand 10.

FIG. 3 is a rear view of the memorabilia ball simulacrum stand 10.

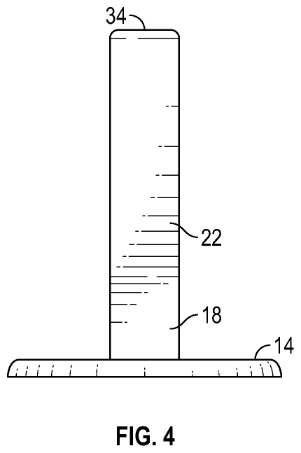

FIG. 4 is a side view of the memorabilia ball simulacrum stand 10.

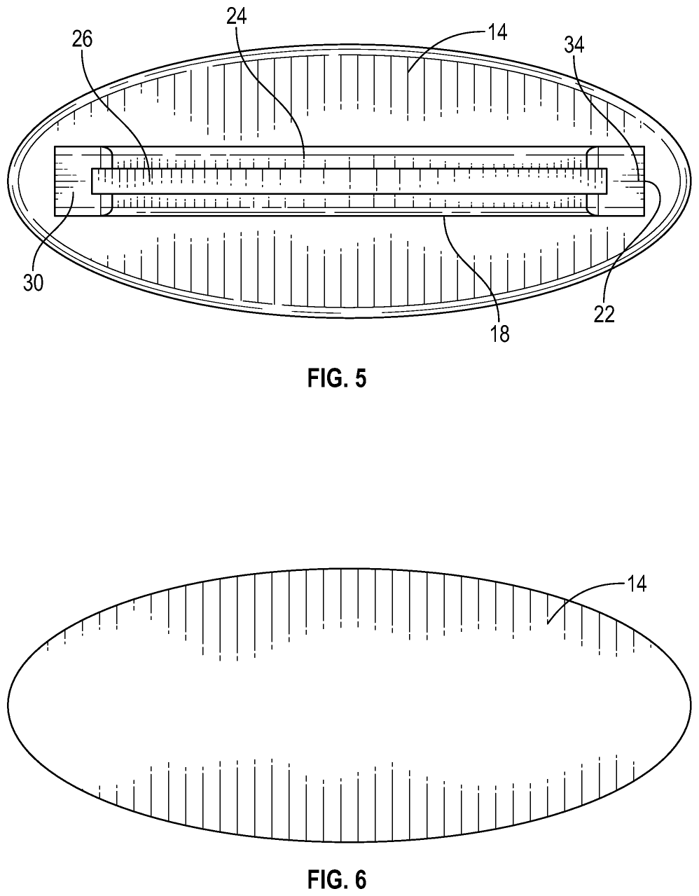

FIG. 5 is a top view of the memorabilia ball simulacrum stand 10.

FIG. 6 is a bottom view of the memorabilia ball simulacrum stand 10.

FIG. 7 is a perspective view of the memorabilia ball simulacrum stand 10 with a memorabilia ball simulacrum 38 inserted into the curved slot 26. The memorabilia ball simulacrum 38 has a thickness T_{MB}. T_{MB} may be about equal to W_{SL}. The memorabilia ball simulacrum has a radius R_{BS}. R_{BS} may be about equal to R_{SL}.

FIG. 8 is a perspective view of the memorabilia ball simulacrum 38 alone.

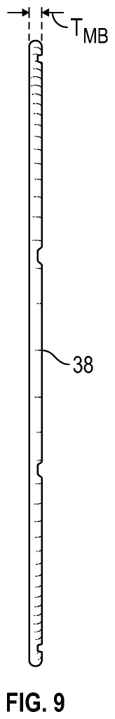

FIG. 9 is a side view of the memorabilia ball simulacrum 38.

The disclosed memorabilia ball simulacrum stand and system has many advantages. The stand can hold a memorabilia ball easily for display, without the need for tools to hang on a wall and/or the trouble of framing the memorabilia ball. The stand can be placed on a table top, shelf, mantle, etc. The stand can be configured to fit any desired shape of memorabilia, including a circular shape, oval shape, face shape, shape of sports equipment, shape of mascot or team emblem, etc. The stand is configured to simply slide the memorabilia into the slot, whereupon the curved holder will hold the memorabilia item securely in place.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A memorabilia ball simulacrum stand, the memorabilia ball simulacrum stand comprising:
a base, wherein the base comprises a top side, and a bottom side that is parallel to the top memorabilia ball simulacrum stand;
a curved holder extending upward and orthogonally from the base, the curved holder comprising:
an outer perimeter located on an outer side of the curved holder;
an inner perimeter located on an inner side of the curved holder;
a first planar surface located on a left side of the curved holder, first planar surface abutting the outer perimeter and the inner perimeter, the first planar surface parallel to the top side and the bottom side;
a second planar surface located on a right side of the curved holder, the second planar surface abutting the outer perimeter and the inner perimeter, the second planar surface parallel to the top side and the bottom side;
a curved slot located within the inner perimeter, the slot configured to hold a memorabilia ball simulacrum.

2. The memorabilia ball simulacrum stand of claim 1, wherein portions of the outer perimeter has the shape of a first circle, and wherein the inner perimeter has the shape of a second circle, and wherein the first circle and second circle have the same center.

3. The memorabilia ball simulacrum stand of claim 1, wherein the curved slot has a radius that is the same as a radius of the memorabilia ball simulacrum

4. The memorabilia ball simulacrum stand of claim 1, wherein the curved slot has a width that is about the same as a thickness of the memorabilia ball simulacrum.

5. The memorabilia ball simulacrum stand of claim 1, wherein the curved slot has a width that is slightly smaller than a thickness of the memorabilia ball simulacrum.

6. The memorabilia ball simulacrum stand of claim 1, wherein the curved slot has a width that is configured to accept a memorabilia ball simulacrum into the curved slot via a press-fit.

7. A memorabilia ball simulacrum system, the memorabilia ball simulacrum system comprising:
a stand, the stand comprising:
a base, wherein the base comprises a top side, and a bottom side that is parallel to the top side, and where the distance from the top side to the bottom side is about 1/20^{th} the height of the memorabilia ball simulacrum stand;
a curved holder extending upward and orthogonally from the base, the curved holder comprising:
an outer perimeter located on an outer side of the curved holder;
an inner perimeter located on an inner side of the curved holder;
a first planar surface located on a left side of the curved holder, the first planar surface abutting the outer perimeter and the inner perimeter, the first planar surface parallel to the top side and the bottom side;
a second planar surface located on a right side of the curved holder, the second planar surface abutting the outer perimeter and the inner perimeter, the second planar surface parallel to the top side and the
a curved slot located within the inner perimeter;
a memorabilia ball simulacrum configured to fit into the curved slot and curved holder.

8. The memorabilia ball simulacrum system of claim 7, wherein portions of the outer perimeter has the shape of a first circle, and wherein the inner perimeter has the shape of a second circle, and wherein the first circle and second circle have the same center.

9. The memorabilia ball simulacrum system of claim 7, wherein the curved slot has a radius that is the same as a radius of the memorabilia ball simulacrum.

10. The memorabilia ball simulacrum system of claim 7, wherein the curved slot has a width that is about the same as a thickness of the memorabilia ball simulacrum.

11. The memorabilia ball simulacrum system of claim 7, wherein the curved slot has a width that is slightly smaller than a thickness of the memorabilia ball simulacrum.

12. The memorabilia ball simulacrum system of claim 7, wherein the curved slot has a width that is configured to accept the memorabilia ball simulacrum into the curved slot via a press-fit.

13. The memorabilia ball simulacrum stand of claim 1, wherein the base has an oval shape or a circular shape.

14. The memorabilia ball simulacrum system of claim 7, wherein the base has an oval shape or a circular shape.
